(19) United States
(12) Patent Application Publication
(10) Pub. No.: US 2005/0011919 A1
(43) Pub. Date: Jan. 20, 2005

(54) Waist-mounted drill holder for a battery-operated electric drill

(76) Inventor: James Durham, Hamilton (CA)

Correspondence Address: GOWLING, LAFLEUR HENDERSON LLP, SUITE 560, 120 KING STREET WEST, PO BOX 1045, LCD 1, HAMILTON, ON, L8N 3R4, CA

(21) Appl. No.: 10/826,397

(22) Filed: Apr. 19, 2004

Related U.S. Application Data
(60) Provisional application No. 60/487,251, filed on Jul. 16, 2003.

(51) Int. Cl. E21B 10/30; A45F 5/00; B25B 5/00

(52) U.S. Cl. 224/248; 224/269

(57) ABSTRACT

A holder for an electric drill is formed by a length of rigid wire shaped to have a generally U-shaped horizontal base having laterally spaced side portions connected by a bight portion at the rear. The base has an open front end and the side portions having ends remote from the bight portion extending into respective substantially vertical laterally spaced upright portions. At least one of the upright portions extends at its upper end into a reverse bend and a downwardly extending clip portion adjacent to the respective upright portion.

RELATED APPLICATION

This application claims priority from U.S. Provisional Patent Application No. 60/487251 filed Jul. 16, 2003.

### FIELD OF INVENTION

This invention relates to electric drill holders which are securable to the waist of a user to enable the drill to be carried thereby when not in use.

### BACKGROUND OF INVENTION

Various drill holders for the above-mentioned purpose are already known. However, one kind of electric drill now commonly in use as a battery compartment at the lower end of the drill handle, and currently available drill holders are not particularly useful for carrying drills of this kind. In fact, it is common for such drills to be carried in pouches secured to the waist of a user and from which it is easy for such a drill to fall out.

It is therefore an object of the present invention to provide an improved waist-mounted drill holder which is especially useful with battery-operated electric drills of the kind mentioned above.

### SUMMARY OF INVENTION

The present invention provides a holder for an electric drill with a main body containing an electric motor and bit receiving chuck, a handle extending downwardly from a rear portion of the main body and a battery compartment at the lower end of the handle for a battery for supplying electric power to the drill motor and chuck.

According to the invention, such a holder comprises a length of rigid wire shaped to have a generally U-shaped horizontal base having laterally spaced side portions connected by a bight portion at the rear, the base having an open front end, the side portions having ends remote from the bight portion extending into respective substantially vertical laterally spaced upright portions, and at least one of the upright portions extending at its upper end into a reverse bend and a downwardly extending clip portion adjacent to the respective upright portion.

A holder in accordance with the invention can be mounted on a belt or waist band worn by user by means of the clip portion and a drill can be mounted in the holder with the battery compartment supported by the base and the upright portions with the handle extending downwardly through the base.

Also, in accordance with the invention, a method of mounting a drill in a holder carried by a user as described above includes causing the handle to engage the bight portion of the base of the holder with the battery compartment of the drill body thereof and allowing the weight of the main drill body to swing the drill about the bight portion until the battery compartment is supported by the base.

### DESCRIPTION OF THE DRAWINGS

Embodiments of the invention will now be described, by way of example, with reference to the accompanying drawings, of which:

FIG. 1 is a side perspective view of a holder in accordance with one embodiment of the present invention mounted on the belt of a user;

FIG. 2 is similar view showing an electric drill being placed in the holder;

FIG. 3 is a similar view showing the drill supported by the holder;

FIG. 4 is a front view of the holder;

FIG. 5 is a side view thereof; and

FIG. 6 is a planned view thereof.

### DESCRIPTION OF PREFERRED EMBODIMENTS

Referring to the drawings, a drill holder is formed from a length of rigid bendable metal or plastic wire shaped to have a generally U-shaped horizontal base 10 with laterally spaced size portions 12, 14, connected by a bight portion 16 at the rear, the base 10 having an open front end 18. The side portions 12, 14, have ends remote from the bight portion 16 extending to respective substantially vertical laterally-spaced upright portions 20, 22. Each upright portion 20, 22 extends at the top into a reverse bend 24, 26 and a downwardly extending clip portion 28, 30, respectively.

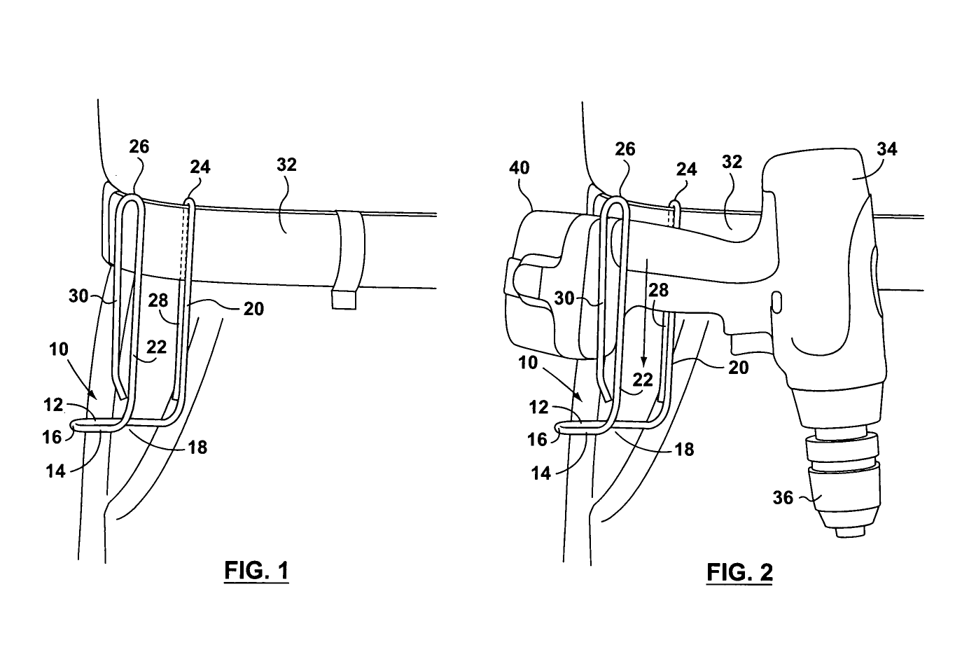

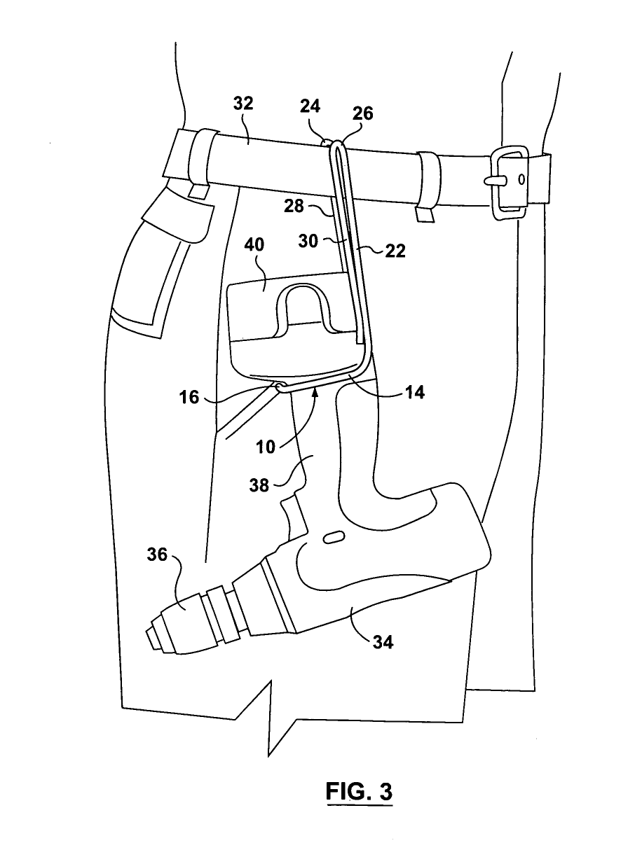

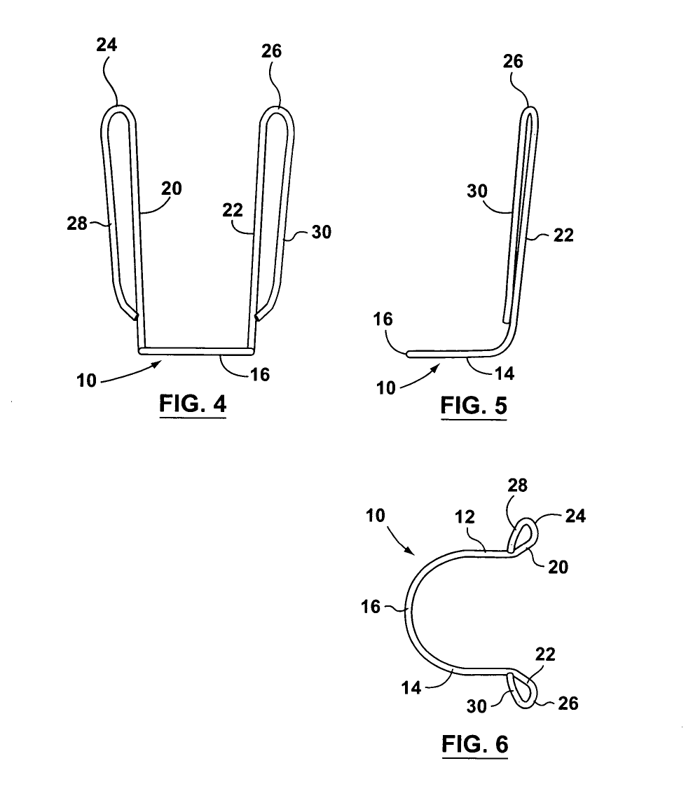

In use, the drill holder is mounted on the belt 32 of a user, as shown in FIGS. 1-3, with the clip portion 28 having been pushed down on the inside of the belt 32 until the reverse bend 24 engages the upper edge thereof, with the open end 18 of the base 10 facing forwardly. The holder is used with an electric drill having a main body 34 containing an electric motor (not shown) and a bit receiving chuck 36, a handle 38 extending downwardly from a rear portion of the main body 34 and a battery compartment 40 at the lower end of the handle 38. It will be noted that the clip portion 28 permits vertical movement and swiveling movement of the drill holder relative to the belt 32.

As shown in FIG. 2, the drill is placed in the holder by lowering it downwardly with the handle 38 horizontal between the side portions 20, 22, and with the main body 34 being forwardly of the holder and the chuck 36 pointing downwardly. When the handle 38 engages the bight portion 16, the greater weight of the main body 34 compared to the weight of the battery compartment 40 causes the drill to pivot about the bight portion 16 until the battery compartment 40 is supported by the base 10. In the drill supporting configuration, the battery compartment 40 engages the bight portion 16, the side portions 12, 14, and the upright portions 20, 22. The drill can be removed from the holder by simply gripping the handle 38 and reversing the motion described above.

The holder is mounted on the right hand side of the user, as shown in FIGS. 1-3, for a right handed user. For a left handed user, the holder is mounted on the left hand side of the user by means of the clip portion 30.

The advantages of the invention will now be readily apparent to a person skilled in the art from the foregoing description of a preferred embodiment, other embodiments will also now be readily apparent to a person skilled in the art.

1. A holder for an electric drill, said holder comprising a length of rigid wire shaped to have a generally U-shaped horizontal base having laterally spaced side portions connected by a bight portion at the rear, the base having an open front end, the side portions having ends remote from the bight portion extending into respective substantially vertical laterally spaced upright portions, and at least one of the upright portions extending at its upper end into a reverse bend and a downwardly extending clip portion adjacent to the respective upright portion.

2. A holder and electric drill assembly, said holder being in accordance with claim 1 and the drill having a main body containing an electric motor and bit receiving chuck, handle extending downwardly from a rear portion of the main body and a battery compartment at the lower end of the handle for a battery for supplying electric power to the drill motor and chuck, the holder being mounted on a belt or waist band worn by a user by means of the clip portion and a drill being mounted in the holder with the battery compartment supported by the base and the upright portions with the handle extending downwardly through the base.

3. A method of mounting the drill in the holder to provide the assembly claimed in claim 2, the method including causing the handle to engage the bight portion of the base of the holder with the battery compartment of the drill body thereof and allowing the weight of the main drill body to swing the drill about the bight portion until the battery compartment is supported by the base.
